(19) United States
(12) Patent Application Publication
(10) Pub. No.: US 2019/0351801 A1
(43) Pub. Date: Nov. 21, 2019

(54) TRAILER ADAPTED TO SUPPORT VARIOUS TYPES OF LOADING EQUIPMENT AND METHOD OF USING THE SAME

(71) Applicant: REMORQUES MARCA INC., St-Jérome (CA)

(72) Inventor: Marc André ROUSSELLE, St-Jérome (CA)

(21) Appl. No.: 15/982,598

(22) Filed: May 17, 2018

(51) Int. Cl. B60P 1/16; B62D 63/08; B60P 1/52; B60P 1/64; B60P 1/36

(52) U.S. Cl. CPC B60P 1/16; B62D 63/08; B60P 1/36; B60P 1/6409; B60P 1/649; B60P 1/52

(57) ABSTRACT

The present disclosure relates to a trailer adapted to support/receive various types of loading equipment. The trailer comprises a chassis having a main frame adapted to be coupled to a motorized vehicle at its main frame front end, a wheel assembly for supporting the main frame, and a guiding structure pivotably mounted on the main frame at its main frame rear end and adapted to pivot between a substantially horizontal transport position and a tilted loading and unloading position. The trailer further comprises a support structure for fixedly supporting the loading equipment having a supporting frame, a translation means mounted on the supporting frame for supporting the supporting frame, and a complementary guiding structure extending from the lower surface of the supporting frame for slidably engaging with the guiding structure of the chassis. Therefore, when the guiding structure is in its tilted loading and unloading position, the loading equipment, fixed on the support structure, may be loaded on or unloaded from the chassis by longitudinally sliding the complementary guiding structure relatively to the guiding structure.

### TECHNICAL FIELD

The present disclosure relates to trailers and to methods of using the same. More particularly, the present disclosure relates to trailers that are adapted to support/receive various types of loading equipment and to methods of using the same.

### BACKGROUND

Conventional trailers are typically tailored to a specific type of loading equipment, such as flat-bed trailers and closed-box trailers. These trailers are not adapted to accommodate other types of loading equipment, and thus multiple trailers are required to satisfy various towing needs. This leads to added expenses and operating costs, as each trailer would need to be purchased, registered, maintained and stored separately.

There is therefore a need for a trailer that is adapted to support/receive different types of loading equipment.

### SUMMARY

It is an object of the present disclosure to provide a trailer adapted to support various types of loading equipment that overcomes or mitigates one or more disadvantages of known trailers or at least provides a useful alternative.

According to an embodiment, there is provided a trailer for connecting to a motorized vehicle and adapted to support a loading equipment, the trailer comprising: a chassis comprising: a main frame defining a main frame front end and a main frame rear end, the main frame being adapted to be coupled to a motorized vehicle at its main frame front end; a wheel assembly for supporting the main frame; and a guiding structure pivotably mounted on the main frame at its main frame rear end and adapted to pivot between a substantially horizontal transport position and a tilted loading and unloading position, the guiding structure defining a longitudinal axis; and a support structure for fixedly supporting the loading equipment, the support structure comprising: a supporting frame defining a lower surface; a translation means mounted about the supporting frame for supporting the supporting frame; and a complementary guiding structure extending from the lower surface of the supporting frame for slidably engaging with the guiding structure of the chassis; wherein when the guiding structure is in its tilted loading and unloading position, the loading equipment, fixed on the support structure, is one of: loaded on and unloaded from the chassis by longitudinally sliding the complementary guiding structure relatively to the guiding structure according to the longitudinal axis.

According to another embodiment, there is provided the trailer as defined above, wherein the guiding structure comprises: a first longitudinal guiding member; and a second longitudinal guiding member spaced apart from the first longitudinal guiding member, the first and second longitudinal guiding members being parallel to the longitudinal axis.

According to a further embodiment, there is provided the trailer as defined above, wherein the complementary guiding structure comprises: a first longitudinal guiding channel; and a second longitudinal guiding channel spaced apart from the first longitudinal guiding channel, the first and second longitudinal guiding channels being parallel to the longitudinal axis when the support structure is loaded on the chassis.

According to yet another embodiment, there is provided the trailer as defined above, wherein the complementary guiding structure comprises: a first set of spaced apart walls extending from the lower surface forming the first longitudinal guiding channel; and a second set of spaced apart walls extending from the lower surface forming the second longitudinal guiding channel.

According to another embodiment, there is provided the trailer as defined above, wherein the complementary guiding structure comprises: a first set of spaced apart rollers within the first longitudinal guiding channel, each one of the first set of spaced apart rollers being rotatably mounted on the first set of spaced apart walls; and a second set of spaced apart rollers within the second longitudinal guiding channel, each one of the second set of spaced apart rollers being rotatably mounted on the second set of spaced apart walls.

According to a further embodiment, there is provided the trailer as defined above, wherein each roller of the first and second sets of spaced apart rollers defines a rolling axis that is perpendicular to the longitudinal axis when the support structure is loaded on the chassis.

According to yet another embodiment, there is provided the trailer as defined above, further comprising a winch mounted on the chassis about a guiding structure front end of the guiding structure for releasably connecting to the support structure for displacing the support structure towards the guiding structure when the guiding structure is in its tilted loading and unloading position.

According to another embodiment, there is provided the trailer as defined above, further comprising a hydraulic piston extending between the main frame and the guiding structure, the hydraulic piston being adapted to extend between a non-extended position, providing the guiding structure in its substantially horizontal transport position, and a fully extended position, providing the guiding structure in its tilted loading and unloading position.

According to a further embodiment, there is provided the trailer as defined above, wherein the wheel assembly comprises: an axle mounted on the main frame about its main frame rear end; and two spaced apart wheels rotatably mounted on the axle.

According to yet another embodiment, there is provided the trailer as defined above, wherein the guiding structure is pivotably mounted on the axle.

According to another embodiment, there is provided the trailer as defined above, wherein each one of the first and second longitudinal guiding members defines a guiding front end and a guiding rear end, and further wherein each one of the first and second longitudinal guiding members comprises a stopper at its guiding front end for receiving the support structure.

According to a further embodiment, there is provided the trailer as defined above, wherein the first and second sets of spaced apart walls forming the first and second longitudinal guiding channels define a wall front end and a wall rear end, the walls of the first and second sets of spaced apart walls forming a wider respective first or second longitudinal guiding channel at their respective wall front ends.

According to yet another embodiment, there is provided the trailer as defined above, wherein each roller of the first and second sets of spaced apart rollers comprises a layer of lubricant. For example, each roller may be lubricated via a central perforated screw coupled to the plurality of rollers. The guiding structure 26 itself is therefore not to be lubricated.

According to another embodiment, there is provided the trailer as defined above, wherein the translation means is positioned at a support structure rear end of the support structure and comprises at least one of: a slider, a skid, a ski, a wheel and a roller.

According to a further embodiment, there is provided the trailer as defined above, further comprising a hitch mounted about the main frame front end for attaching the main frame to the motorized vehicle and a trailer supporting device mounted about the main frame front end for supporting the main frame.

According to yet another embodiment, there is provided the trailer as defined above, further comprising a storage bin mounted on the chassis.

According to another embodiment, there is provided the trailer as defined above, further comprising a backup camera mounted about the main frame rear end and operatively coupled to the motorized vehicle.

### BRIEF DESCRIPTION OF THE DRAWINGS

Further features and advantages of the present disclosure will become apparent from the following detailed description, taken in combination with the appended drawings, in which

FIG. 1 is a perspective view of a chassis of the trailer in accordance with an embodiment;

FIG. 2 is a perspective view of the chassis of FIG. 1, with its guiding structure positioned in the tilted loading and unloading position, ready to slidably receive the loading equipment to be mounted on the support structure;

FIG. 3 is a perspective view of the chassis of FIG. 1, with its guiding structure positioned in the tilted loading and unloading position, slidably receiving the loading equipment to be mounted on the support structure;

FIG. 4 is a perspective view of the chassis of FIG. 1, with its guiding structure positioned in the substantially horizontal transport position, fully supporting the loading equipment mounted on the support structure;

FIG. 5 is a top plan view of the chassis of FIG. 1;

FIG. 6 is a bottom plan view of the chassis of FIG. 1;

FIG. 7 is a bottom perspective view of the support structure shown in FIGS. 2-4;

FIG. 8 is a top plan view of the support structure of FIG. 7; and

FIG. 9 is a bottom plan view of the support structure of FIG. 7.

### DETAILED DESCRIPTION

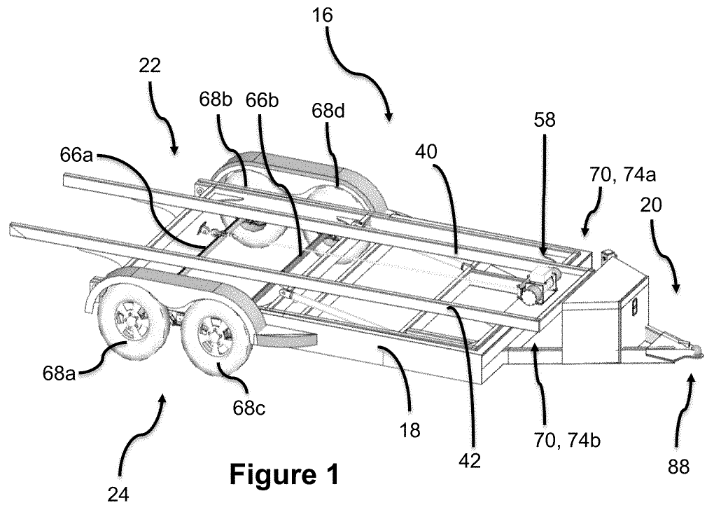

Referring now to the drawings and more particularly to FIGS. 1-4, there is shown a trailer 10 that is adapted to support/receive various types of loading equipment 14. Examples of such loading equipment 14 may include, but are not limited to, a flat-bed trailer, an open trailer with or without removable panels, a closed box trailer, a construction trailer, a dump trailer, a towing platform, a hunting camp, a mini home, a fishing cabin, a nacelle, a platform nacelle, a dolly, a trolley, a crane, a clamp for forestry, a forklift, a forklift with a scale, a boat trailer, a farmer's cage, an emptying container, a removable rail system for custom loading equipment, a trailer for road signs, an event container, a mobile stage, a mobile platform, and the like.

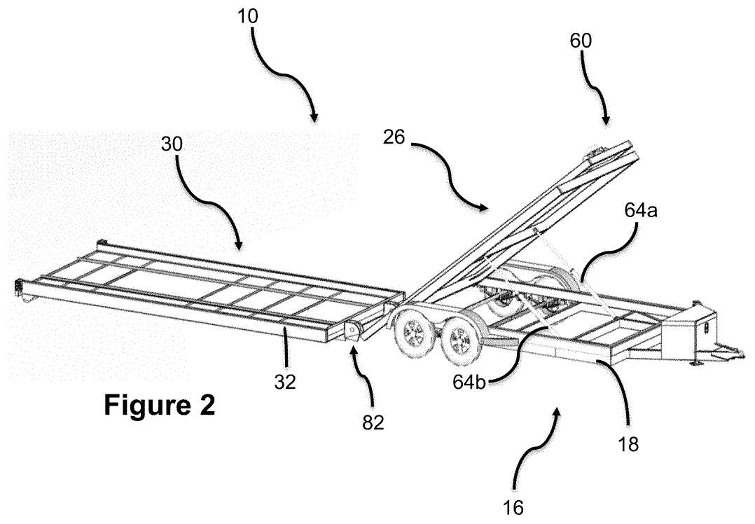

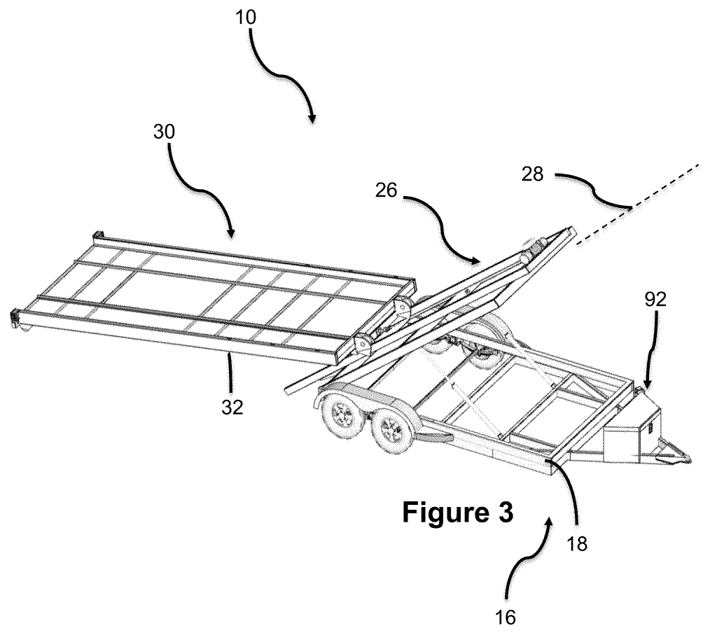

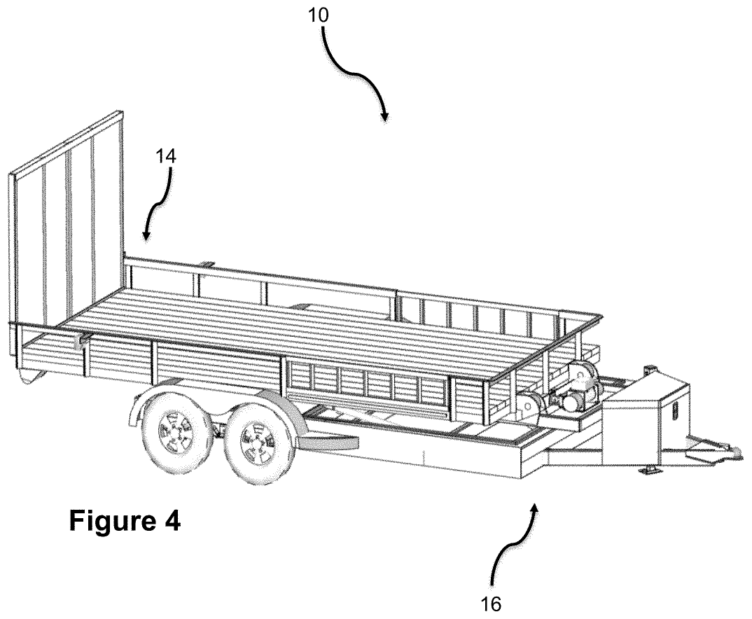

Trailer 10 is configured such as to be releasably connected to a motorized vehicle. Trailer 10 comprises a chassis 16 which includes a main frame 18. Main frame 18 defines a main frame front end 20 and a main frame rear end 22, opposite end 20. Main frame 18 is further adapted to be coupled to the motorized vehicle at its main frame front end 20. Chassis 16 further comprises a wheel assembly 24 for supporting the main frame 18 above the ground surface as well as a guiding structure 26 which is pivotably mounted on main frame 18 at its main frame rear end 22. Guiding structure 26 is adapted to pivot between a substantially horizontal transport position (FIG. 4) and a tilted loading and unloading position (FIGS. 2-3). As best shown in FIGS. 2 and 3, guiding structure 26 defines a longitudinal axis 28. Trailer 10 further comprises a support structure 30 fixedly supporting the loading equipment 14. Support structure 30 comprises a supporting frame 32 which defines an upper surface 33 and a lower surface 34. Support structure 30 further comprises a translation means 36 which is mounted on the supporting frame 32 (at the support structure rear end 84) for supporting the supporting frame 32. Support structure 30 further comprises a complementary guiding structure 38, which extends, or downwardly extends, from the lower surface 34 of the supporting frame 32 for slidably engaging with the guiding structure 26 of chassis 16. Therefore, in use, when the guiding structure 26 is in its tilted loading and unloading position (FIGS. 2 and 3), the loading equipment 14, which is fixed on the support structure 30, may be loaded on, or unloaded from, the chassis 16 by longitudinally sliding the complementary guiding structure 38 relatively to the guiding structure 26 according to the longitudinal axis 28. Thus, guiding structure 26 combined with complementary guiding structure 38 enable loading the loading equipment 14 onto chassis 16 as well as unloading the loading equipment 14 off chassis 16.

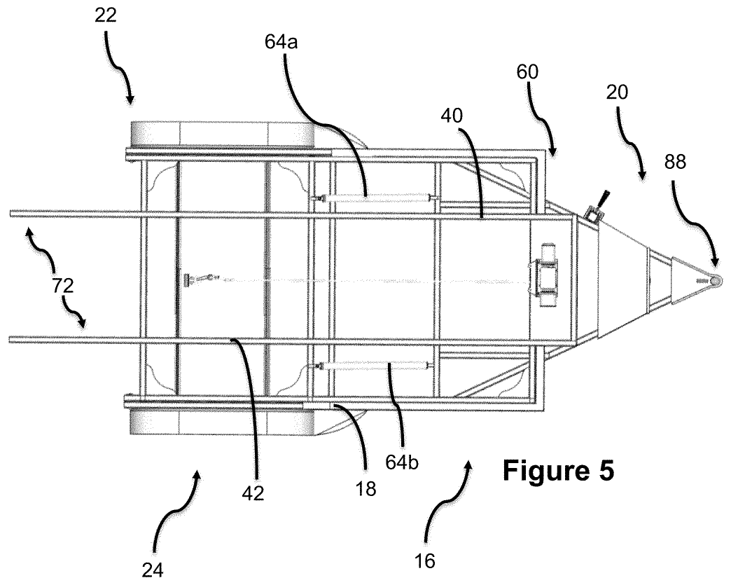

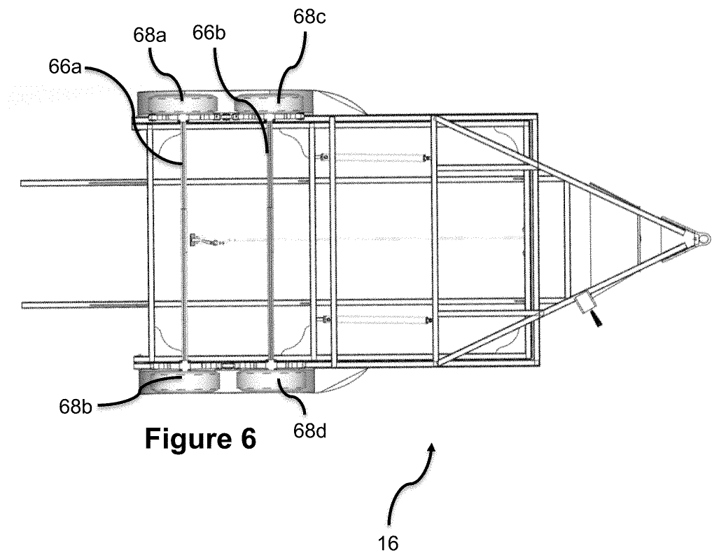

As best shown in FIGS. 1, 5 and 6, the guiding structure 26 comprises a first longitudinal guiding member 40 (or a first longitudinal beam 40) and a second longitudinal guiding member 42 (or second longitudinal beam 42), which is spaced apart from first longitudinal guiding member 40. First and second longitudinal guiding members 40, 42 are parallel to longitudinal axis 28.

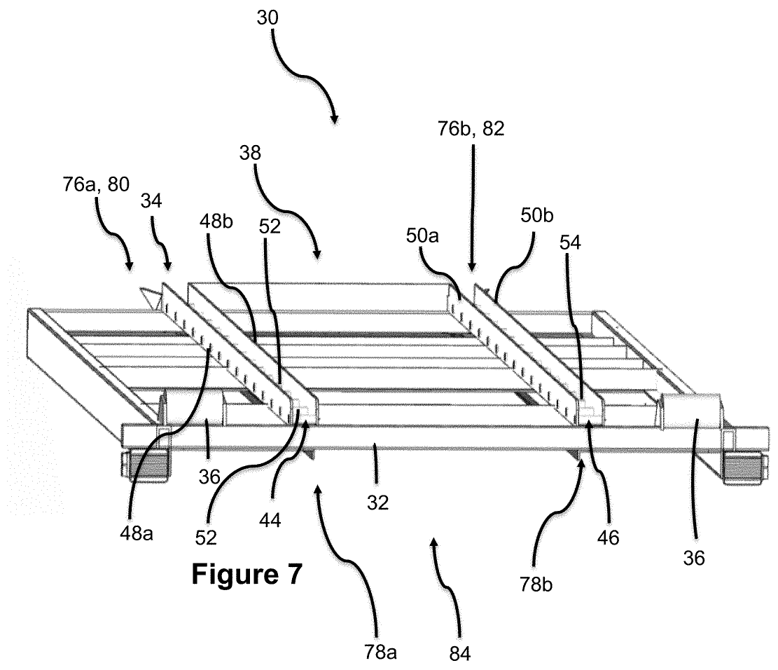

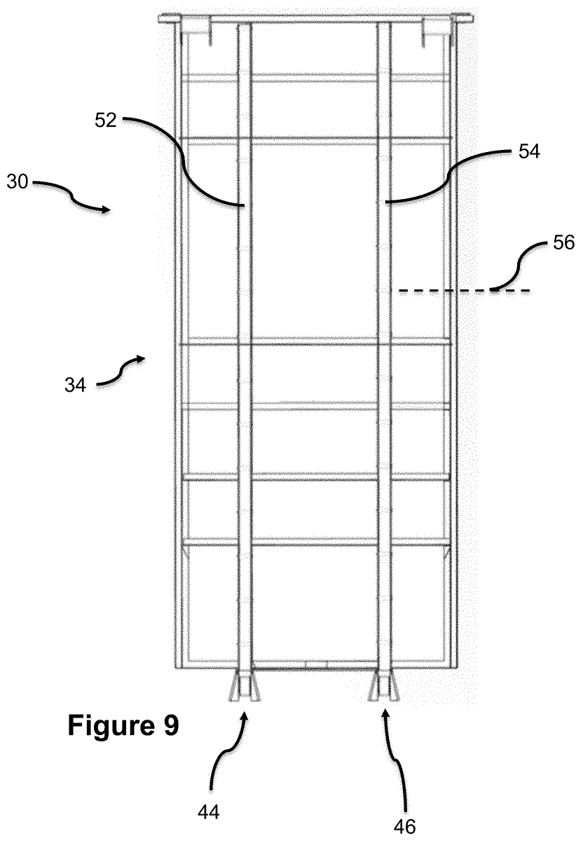

Now referring to FIGS. 7 and 9, there is shown that complementary guiding structure 38 comprises a first longitudinal guiding channel 44 and a second longitudinal guiding channel 46, which is spaced apart from the first longitudinal guiding channel 44. First and second longitudinal guiding channels 44, 46 are further shown to be parallel to longitudinal axis 28, when support structure 30 is loaded on the chassis 16 (FIG. 4). The complementary guiding structure 38 further comprises a first set of spaced apart walls 48a, 48b which extend, in a perpendicular manner, downwardly from the lower surface 34. Walls 48a, 48b together with the lower surface 34 form the first longitudinal guiding channel 44. The complementary guiding structure 38 further comprises a second set of spaced apart walls 50a, 50b which extend, in a perpendicular manner, downwardly from the lower surface 34. Walls 50a, 50b together with the lower surface form the second longitudinal guiding channel 46. It is to be understood that a person skilled in the art to which the trailer 10 pertains would understand that longitudinal channels 44, 46 may take any other shapes and/or configurations, as long as it guides the complementary guiding structure 38 along the guiding structure 26 once the guiding structure 26 itself is in its tilted loading and unloading position. For example, walls 48a, 48b, 50a, 50b may not be continuous along length of the supporting frame 32, or they may not be perpendicular according to the lower surface 34.

Still referring to FIGS. 7 and 9, there is shown that the complementary guiding structure 38 further comprises a first set of spaced apart rollers 52 within the first longitudinal guiding channel 44 and a second set of spaced apart rollers 54 within the second longitudinal guiding channel 46. Accordingly, each roller 52 is rotatably mounted on walls 48a, 48b, while each roller 54 is rotatably mounted on walls 50a, 50b. As shown, each roller of the first and second sets of spaced apart rollers 52, 54 defines a rolling axis 56, that is perpendicular to the longitudinal axis 28 when the support structure 30 is loaded on the chassis 16 (FIG. 4). It is to be mentioned that a person skilled in the art would understand that such rollers 52, 54, may be replaced by other rolling means, bearings for example, as long as it provides an improved relative displacement between the complementary guiding structure 38 on the guiding structure 26. Other configurations may be used to provide such displacement. Indeed, complementary guiding structure may be provided without roller, but with other sliding means, metallic or polymeric materials (such as HDPE for instance), that are covered or not with lubricant materials or compositions, as long as it easily slide and longitudinally displace relatively to guiding structure 26. However, it is important to be noted that since the plurality of rollers 52, 54 are covered by their respective walls 48a, 48b, 50a, 50b as long as by lower surface 34 defined by the supporting frame 32, and thereby, covered by the loading equipment 14 that is fixed/secured to the support structure 30, rollers remain in good shape, even when exposed to harsh weather conditions (rain, snow, cold temperatures, etc.). The distance between two adjacent rollers may be, for example, between 1 inch and 72 inches.

Still referring to the drawings and more particularly to FIGS. 1 to 4, there is shown that trailer 10 further comprises a winch 58, which is mounted on the chassis 16, more particularly on guiding structure 26 about guiding structure front end 60. Winch 58 is adapted to releasably connect to support structure 30 such as to displace the support structure 30 towards the guiding structure 26 when the guiding structure 26 is in its tilted loading and unloading position (FIG. 3). Such winch facilitates both loading and unloading of loading equipment 14. It is to be mentioned that trailer 10 may comprise more than one winch for heavy applications such as, without limitation, vehicle towing, making it possible to keep both the loading equipment 14 and the vehicle (not shown) attached simultaneously.

Trailer 10 also comprises spaced apart hydraulic pistons 64a, 64b, where each piston extends between main frame 18 and guiding structure 26. Therefore, each hydraulic piston is adapted to extend between a non-extended position (FIGS. 1 and 4), providing the guiding structure 26 in its substantially horizontal transport position, and a fully extended position (FIGS. 2 and 3), providing the guiding structure 26 in its tilted loading and unloading position. It is to be mentioned that one or more hydraulic piston(s) and/or other mechanisms that would help in tilting the guiding structure 26 relatively to main frame 18 could be used. Hydraulic pistons 64a, 64b help to position guiding structure 26 at a suitable angle relatively to main frame 18 in order to load or unload loading equipment 14 onto chassis 16. It is further to be mentioned that a spare wheel/tire may further be included and stored on chassis 16, next to winch 58 for instance, in case one of above-mentioned wheels cannot be used.

Referring now to FIGS. 2 and 3, there is shown that wheel assembly 24 comprises spaced apart and parallel axles 66a, 66b, that are mounted on main frame 18 about its main frame rear end 22 and spaced apart wheels 68a, 68b and 68c, 68d that are rotatably mounted on their respective axles 66a, 66b. It is to be mentioned that one or more axle(s) may be used to accommodate the different purposes of trailer 10 itself. Accordingly, guiding structure 26 is pivotably mounted on axle 66a.

Furthermore, it is to be mentioned that first and second longitudinal guiding members 40, 42 each defines a guiding front end 70 and a guiding rear end 72. Therefore, first and second longitudinal guiding members 40, 42 each comprises a stopper 74a, 74b at its guiding front end 70 for receiving/stopping the support structure 30. Moreover, first and second sets of spaced apart walls that are forming the first and second longitudinal guiding channels 44, 46 each defines a wall front end 76a, 76b and a wall rear end 78a, 78b. As shown, the first and second sets of spaced apart walls are forming respective wider first and second longitudinal guiding channel 80, 82 at their respective wall front ends 76a, 76b. Indeed, ends 76a, 76b of the first and second sets of spaced apart walls 48a, 48b, 50a, 50b are to be angled to guide first and second longitudinal guiding members 40, 42 within the first and second longitudinal guiding channels 44, 46 such that perfect alignment of chassis 16 with the loading equipment 14 secured on the support structure 30 is not a need to easily load the loading equipment 14 onto chassis 16.

It is important to be mentioned that each roller of the first and second sets of spaced apart rollers 52, 54 comprises a layer of lubricant (or greasy component), allowing loading equipment 14 to easily be loaded onto the chassis 16 via guiding structure 26 and its complementary guiding structure 38.

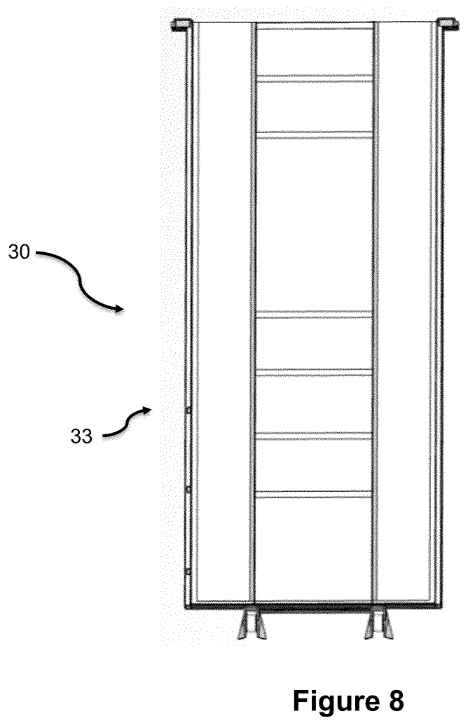

Moreover, even if the translation means 36 according to FIGS. 1 to 4 and 7 to 9 are shown to be rollers, it is important to be mentioned that a person skilled in the art to which trailer 10 pertains would understand that any other translation device may be used about a support structure rear end 84 or elsewhere on the support structure and/or on the loading equipment itself, such as, without limitations, sliders, skids, skis, wheels and the like. It is therefore to be noted that the loading equipment itself may comprise the translation means 36 to ease the loading equipment's 14 longitudinal movement along the ground upon its loading or unloading onto chassis 16 to prevent the loading equipment 14 from being damaged when interfacing with the ground surface. The nature of translation means 36 may vary depending on the ground surface itself. As an example, when the ground surface consists primarily of ice, translation means 30 may include sliders or skids, whereas if the ground surface were snowy, translation means 30 may comprise skis. If the ground surface is bare and comprises for example concrete or gravel, translation means 30 may comprise wheels or rollers to facilitate the loading and unloading processes. Translation means 30 may further comprise larger rollers to facilitate lateral movement on surfaces such as farming lands and rugged terrain.

Still referring to FIGS. 1 to 4, trailer 10 further comprises a hitch 88 that is mounted about the main frame front end 20 for attaching the main frame 18 to the motorized vehicle, a pickup truck for example, and a trailer supporting device (not shown) that is also mounted about the main frame front end 20 for supporting main frame 18. Such supporting device may be a trailer jack, to support the trailer 10 when unattached to the motorized vehicle and to assist with attachment to the motorized vehicle.

Trailer 10 further comprises a storage bin 92 mounted on the chassis 16 to satisfy various storage needs.

Trailer 10 may further comprise a backup camera that can be mounted about the main frame rear end 22 and that may be operatively coupled to the motorized vehicle. The backup camera (not shown) may be attached to trailer 10 or to motorized vehicle itself to assist a driver in maneuvering the vehicle so that the trailer 10 may be easily attached.

It is to be mentioned that according to FIGS. 2-4, loading equipment 14 is illustratively shown as a flat-bed, but may be any type of loading equipment, examples of which are listed above.

Therefore, still referring to FIGS. 1 to 4, in use, loading equipment 14 is loadable onto chassis 16 by first aligning chassis 16 with loading equipment 14 fixedly supported by, or secured to, support structure 30 and positioned on the ground surface such that guiding structure 26 is aligned (or roughly aligned) with complementary guiding structure 38 (FIG. 2). Then, guiding structure 26 is angled to a suitable angle in its tilted loading and unloading position relative to main frame 18, thanks to hydraulic pistons 64a, 64b (FIG. 2). Next, winch 58 is loosened and attached to the loading equipment 14, so that when winch 58 is activated, loading the loading equipment 14 onto chassis 16 is possible thanks to slidable engagement of the complementary guiding structure 38 onto guiding structure 26 (FIG. 3). Once loading equipment 14 is fully loaded onto chassis 16 (FIG. 4), guiding structure is lowered to its substantially horizontal transport position providing the hydraulic pistons 64a, 64b in their non-extended position, rendering trailer 10 (chassis combined with loading equipment secured onto support structure) useable for towing. It is however to be mentioned that a person skilled in the art to which trailer 10 pertains would understand that loading equipment 14 that has already been loaded onto chassis 16 could be unloaded by reversing the steps described above.

While preferred embodiments have been described above and illustrated in the accompanying drawings, it will be evident to those skilled in the art that modifications may be made therein without departing from the essence of this disclosure. Such modifications are considered as possible variants comprised in the scope of the disclosure.

1. A trailer for connecting to a motorized vehicle and adapted to support a loading equipment, the trailer comprising:
a chassis comprising:
a main frame defining a main frame front end and a main frame rear end, the main frame being adapted to be coupled to a motorized vehicle at its main frame front end;
a wheel assembly for supporting the main frame; and
a guiding structure pivotably mounted on the main frame at its main frame rear end and adapted to pivot between a substantially horizontal transport position and a tilted loading and unloading position, the guiding structure defining a longitudinal axis; and
a support structure for fixedly supporting the loading equipment, the support structure comprising:
a supporting frame defining a lower surface;
a translation means mounted about the supporting frame for supporting the supporting frame; and
a complementary guiding structure extending from the lower surface of the supporting frame for slidably engaging with the guiding structure of the chassis;
wherein when the guiding structure is in its tilted loading and unloading position, the loading equipment, fixed on the support structure, is one of: loaded on and unloaded from the chassis by longitudinally sliding the complementary guiding structure relatively to the guiding structure according to the longitudinal axis.

2. The trailer of claim 1, wherein the guiding structure comprises:
a first longitudinal guiding member; and
a second longitudinal guiding member spaced apart from the first longitudinal guiding member,
the first and second longitudinal guiding members being parallel to the longitudinal axis.

3. The trailer of claim 2, wherein the complementary guiding structure comprises:
a first longitudinal guiding channel; and
a second longitudinal guiding channel spaced apart from the first longitudinal guiding channel,
the first and second longitudinal guiding channels being parallel to the longitudinal axis when the support structure is loaded on the chassis.

4. The trailer of claim 3, wherein the complementary guiding structure comprises:
a first set of spaced apart walls extending from the lower surface forming the first longitudinal guiding channel; and
a second set of spaced apart walls extending from the lower surface forming the second longitudinal guiding channel.

5. The trailer of claim 4, wherein the complementary guiding structure comprises:
a first set of spaced apart rollers within the first longitudinal guiding channel, each one of the first set of spaced apart rollers being rotatably mounted on the first set of spaced apart walls; and
a second set of spaced apart rollers within the second longitudinal guiding channel, each one of the second set of spaced apart rollers being rotatably mounted on the second set of spaced apart walls.

6. The trailer of claim 5, wherein each roller of the first and second sets of spaced apart rollers defines a rolling axis that is perpendicular to the longitudinal axis when the support structure is loaded on the chassis.

7. The trailer of claim 1, further comprising a winch mounted on the chassis about a guiding structure front end of the guiding structure for releasably connecting to the support structure for displacing the support structure towards the guiding structure when the guiding structure is in its tilted loading and unloading position.

8. The trailer of claim 1, further comprising a hydraulic piston extending between the main frame and the guiding structure, the hydraulic piston being adapted to extend between a non-extended position, providing the guiding structure in its substantially horizontal transport position, and a fully extended position, providing the guiding structure in its tilted loading and unloading position.

9. The trailer of claim 1, wherein the wheel assembly comprises:
an axle mounted on the main frame about its main frame rear end; and
two spaced apart wheels rotatably mounted on the axle.

10. The trailer of claim 9, wherein the guiding structure is pivotably mounted on the axle.

11. The trailer of claim 2, wherein each one of the first and second longitudinal guiding members defines a guiding front end and a guiding rear end, and further wherein each one of the first and second longitudinal guiding members comprises a stopper at its guiding front end for receiving the support structure.

12. The trailer of claim 4, wherein the first and second sets of spaced apart walls forming the first and second longitudinal guiding channels define a wall front end and a wall rear end, the walls of the first and second sets of spaced apart walls forming a wider respective first or second longitudinal guiding channel at their respective wall front ends.

13. The trailer of claim 5, wherein each roller of the first and second sets of spaced apart rollers comprises a layer of lubricant.

14. The trailer of claim 1, wherein the translation means is positioned at a support structure rear end of the support structure and comprises at least one of: a slider, a skid, a ski, a wheel and a roller.

15. The trailer of claim 1, further comprising a hitch mounted about the main frame front end for attaching the main frame to the motorized vehicle and a trailer supporting device mounted about the main frame front end for supporting the main frame.

16. The trailer of claim 1, further comprising a storage bin mounted on the chassis.

17. The trailer of claim 1, further comprising a backup camera mounted about the main frame rear end and operatively coupled to the motorized vehicle.
